(19) United States
(12) Patent Application Publication
(10) Pub. No.: US 2020/0362167 A1
(43) Pub. Date: Nov. 19, 2020

(54) ELECTROPLATABLE HIGH-DENSITY PLASTIC

(71) Applicant: Pontex Polyblend Co.,Ltd, Taichung City (TW)

(72) Inventor: SHIH-YUAN LIAO, Taichung City (TW)

(73) Assignee: Pontex Polyblend Co.,Ltd, Taichung City (TW)

(21) Appl. No.: 16/410,077

(22) Filed: May 13, 2019

(51) Int. Cl. C08L 77/06; C08L 81/02; C08K 3/20

(52) U.S. Cl. CPC C08L 77/06; C08K 2003/2213; C08K 3/20; C08L 81/02

(57) ABSTRACT

An electroplatable high-density plastic comprises cerium oxide and at least one of polyphenylene sulfide (PPS) and high-rigidity nylon (MXD6). The polyphenylene sulfide and high-rigidity nylon make the article made of the electroplatable high-density plastic electroplatable, such that a metal layer can be electroplated thereon to give a metallic luster. Simultaneously, the polyphenylene sulfide causes the article to have a metal-like crisp sound when colliding. In addition, the cerium oxide can increase the density of the electroplatable high-density plastic, and confer the articles made of the electroplatable high-density plastic the properties of hard texture, thereby resulting in the advantages of folding and scratch resistance and low hygroscopicity, which not only expands the application range of the articles made of the electroplatable high-density plastic, but also enhances the value thereof.

### BACKGROUND OF THE INVENTION

### Technical Field

The invention relates to plastics, in particular to a high-density plastic.

### Description of Related Art

Plastic articles, which have the advantages of low cost and mass production, play an indispensable role in modern society.

Although plastic articles are more convenient to manufacture than metal or wood articles, their range of application is still very limited due to the disadvantages of low density and low support force. Taking the support frame as an example, the support frame made of the plastic is only used to support small objects because of the lack of support force. In addition, when the support frame is used to support a heavy TV set, the material of the support frame is often chosen from metals or woods with high density rather than plastics such that the overall center of gravity of the TV set and the support frame is close to the ground to achieve a stable effect.

Furthermore, plastic articles have low hardness, so they are easily deformed by force and even scratched on the surface. Therefore, both the article that has to withstand the large external force or must be precisely assembled, such as the bearing, and the article that is required to be scratch-resistant, such as the bathroom accessory, are not suitable to be made of plastics.

Furthermore, due to the light weight, people often think plastic articles cheap and low-quality, so no matter how exquisitely the plastic articles are made, consumers may still not buy the plastic articles. If the plastic articles keep unchanged, they will never have an increased value.

### BRIEF SUMMARY OF THE INVENTION

In view of the above, the purpose of the present invention is to provide an electroplatable high-density plastic with the characteristics of high density and hard texture. The electroplatable high-density plastic can be electroplated to give a metallic luster and a crisp sound when being collided, which sounds like a metal is collided. The products made of the electroplatable high-density plastic of the present invention have a wide range of application.

In order to achieve the above purposes, the present invention provides an electroplatable high-density plastic, which comprises cerium oxide, and at least one of polyphenylene sulfide (PPS) and high-rigidity nylon MXD6.

The effect of the present invention lies in that the polyphenylene sulfide and high-rigidity nylon make the article made of the electroplatable high-density plastic electroplatable, such that a metal layer can be electroplated thereon to give a metallic luster. Simultaneously, the polyphenylene sulfide causes the article to have a crisp sound when being collided, which sounds like a metal is collided. In addition, the cerium oxide can increase the density of the electroplatable high-density plastic, and confer the articles made of the electroplatable high-density plastic the properties of hard texture, thereby resulting in the advantages of folding and scratch resistance and low hygroscopicity, which not only expands the application range of the articles made of the electroplatable high-density plastic, but also enhances the value thereof.

### DETAILED DESCRIPTION OF THE INVENTION

An electroplatable high-density plastic according to a preferred embodiment of the present invention comprises cerium oxide (CeO₂), and at least one of polyphenylene sulfide (PPS) and high-rigidity nylon (MXD6). In this embodiment, the average particle diameter of the cerium oxide is 0.2 to 40 μm, but is not limited thereto. The cerium oxide and the at least one of polyphenylene sulfide and high-rigidity nylon (MXD6) are stirred and mixed by a mixer, and then placed in an injection molding machine to inject the electroplatable high-density plastic into a mold to form a specific shape. In addition, since the polyphenylene sulfide is white, the coloring material can be stirred together with the polyphenylene sulfide and the cerium oxide before the injection molding to form articles of different colors.

When an article made of polyphenylene sulfide (or the high-rigidity nylon) and cerium oxide that are served as the plastic raw materials, is collided, the article will generate a crisp sound like a metal collision due to the material properties of polyphenylene sulfide (or the high-rigidity nylon). Cerium oxide is a material with higher hardness, so it can resonate with polyphenylene sulfide (or the high-rigidity nylon) to enhance the crisp sound.

In addition, due to the material properties of polyphenylene sulfide and the high-rigidity nylon, the article produced therefrom has electroplatability. The article can be further electroplated to have a surface metal layer (such as an aluminum layer), so that the article has a metallic luster, and its appearance is almost the same as that of a metal product, thereby enhancing the product value in the consumer's mind.

Cerium oxide has a large molecular weight and can increase the density of plastics. Therefore, compared with the conventional plastics, the high-density plastics are relatively heavy and have a relative hard texture, which provides better support and scratch resistance, and relatively extensive scope of application. Taking the support frame as an example, but not limited thereto, most of the support frame made of conventional plastics can only be used for supporting light articles, such as mobile phones, stationery, etc. However, for large and heavy articles, such as the TV set, if placed on a support frame made of conventional plastic, not only will there be doubts of insufficient support force, but the overall center of gravity of the support frame and the TV set is too high due to the light weight of the plastic support frame, thereby affecting the stability and causing the TV set to slightly shake and collapse. The support frame made of the high-density plastic described above not only has better supporting force, but also can be used for supporting articles such as the TV set and the like because of its relatively heavy weight (compared with the support frame made of conventional plastics having the same volume). The overall center of gravity of the article, e.g. the TV set, and the support frame moves toward the support frame and close to the ground, thereby improving the overall stability.

All the articles that can be produced by injection molding can be made of the electroplatable high-density plastic. In addition, the articles made of the electroplatable high-density plastic can not only replace the conventional plastic products, but also have the characteristics of hard texture, high deformation resistance and high density, so that the electroplatable high-density plastic can be used in the fields that never use the conventional plastic products. For example, the electroplatable high-density plastic can be used to make a bearing, or even a musical instrument, such as: Ocarina, clarinet, etc.

Another example is the bathroom accessory (such as the showerhead). In order to have both good texture and impact resistance, the conventional bathroom accessory is mostly made of metal. However, the parts of the bathroom accessory are complicated in structure and large in number. When the parts of the bathroom accessory are made of metal, complicated processing steps, including: cutting, grinding, polishing, etc. will be required. Moreover, with the increase of the complexity of the structures of the parts, the processing difficulty will also increase, which will not only greatly increase the production cost, but also lengthen the processing time.

In contrast, if the bathroom accessory is made of high-density plastics, once the mold is completed, the parts of the bathroom accessory can be produced quickly in large quantities by injection molding without additional processing steps. Even if the parts are complicated in structure, the technical difficulties to be overcome with respect to injection molding are relatively simple, as compared to metal processing.

Polyphenylene sulfide and the high-rigidity nylon have the characteristics of non-hygroscopicity and low hygroscopicity, respectively, so the high-density plastic can be made into the rotor of the rear-mirror, and the rotor will not expand due to water absorption, and can have longer service life. In addition, the high-rigidity nylon has the advantage of low coefficient of thermal expansion, so the articles made of the plastic with high density containing the high-rigidity nylon, such as hot-water bottles, the tee tubes of a water heater, etc. are suitable to be used in a high temperature environment and will not be easily deformed, and thus has dimensional stability.

The electroplatable high-density plastic can be used to manufacture articles that have high density, heavy weight, hard texture, and the metallic appearance. Besides, the articles produce a crisp sound like metal collision when colliding, and thus can replace almost the metal products. In addition, using the electroplatable high-density plastic to manufacture articles has the advantage of rapid and mass production and is therefore superior to the metal processing.

The electroplatable high-density plastic is increased in density by cerium oxide. In other words, the higher the weight percentage of cerium oxide in the plastic, the higher the density of the plastic. The manufacturer can adjust the density of the plastic by adjusting the ratio of polyphenylene sulfide (or the high-rigidity nylon) to cerium oxide during manufacturing.

Please refer to Tables 1 and 2 below, which show the influence of polyphenylene sulfide and cerium oxide at different weight ratios on the physical properties of corresponding high-density plastics.

TABLE 1
Weight percentages of polyphenylene sulfide and
cerium oxide in each product.

| Raw | Product | | | | | | |
|---|---|---|---|---|---|---|---|
| materials | P1 | P2 | P3 | P4 | P5 | P6 | P7 |
| Cerium oxide (%) | 20 | 30 | 40 | 50 | 60 | 70 | 80 |
| Polyphenylene | 80 | 70 | 60 | 50 | 40 | 30 | 20 |
| sulfide (%) | | | | | | | |

TABLE 2
Comparison of physical properties of each product in Table 1.

| Physical | | | | | | | | | |
|---|---|---|---|---|---|---|---|---|---|
| properties | Unit | ASTM | P1 | P2 | P3 | P4 | P5 | P6 | P7 |
| Tensile | kg/cm² | D638 | 652 | 834 | 857 | 810 | 800 | 850 | 700 |
| strength | | | | | | | | | |
| Elongation | % | D640 | 2.4 | 3.5 | 3 | 1.99 | 1.8 | 0.2 | 0.8 |
| rate | | | | | | | | | |
| Flexural | kg/cm² | D790 | 1260 | 1330 | 1330 | 1385 | 1370 | 1100 | 772 |
| strength | | | | | | | | | |
| Flexural | kg/cm² | D790 | 40500 | 44000 | 51000 | 58000 | 77000 | 111000 | 169000 |
| modulus | | | | | | | | | |
| Impact | kg/cm/ | D256 | 5 | 6 | 6 | 6.68 | 7.3 | 4.6 | 4 |
| strength | cm | | | | | | | | |
| (23° C.) | | | | | | | | | |
| Pencil | — | D2240 | HB | HB | HB | HB | F | 2H | 3H |
| hardness | | | | | | | | | |
| Heat | ° C. | D648 | 122 | 122 | 120 | 166 | 160 | 150 | 120 |
| distortion | | | | | | | | | |
| temp. | | | | | | | | | |
| Density | g/cm³ | D792 | 1.6 | 1.763 | 1.97 | 2.254 | 2.604 | 3.1 | 3.73 |
| Thermal | 10⁻⁵/° C. | D696 | 4.5 | 4.1 | 3.8 | 3.5 | 3.2 | 2.8 | 2.5 |
| expansion | | | | | | | | | |
| coefficient | | | | | | | | | |

Please refer to Tables 3 and 4 below, which show the influence of the high-rigidity nylon and cerium oxide at different weight ratios on the physical properties of corresponding high-density plastics.

TABLE 3
Weight percentages of the high-rigidity nylon and
cerium oxide in each product.

| Raw | Product | | | | | | |
|---|---|---|---|---|---|---|---|
| materials | P1 | P2 | P3 | P4 | P5 | P6 | P7 |
| Cerium oxide (%) | 20 | 30 | 40 | 50 | 60 | 70 | 80 |
| High-rigidity nylon | 80 | 70 | 60 | 50 | 40 | 30 | 20 |
| (%) | | | | | | | |

TABLE 4
Comparison of physical properties of each product in Table 3.

| Physical | | | | | | | | | |
|---|---|---|---|---|---|---|---|---|---|
| properties | Unit | ASTM | P1 | P2 | P3 | P4 | P5 | P6 | P7 |
| Tensile | kg/cm² | D638 | 900 | 1000 | 1100 | 1050 | 1000 | 950 | 900 |
| strength | | | | | | | | | |
| Elongation | % | D640 | 5 | 3 | 1 | 1 | 0.8 | 0.8 | 0.7 |
| rate | | | | | | | | | |
| Flexural | kg/cm² | D790 | 1500 | 1600 | 1600 | 1400 | 1360 | 1350 | 1360 |
| strength | | | | | | | | | |
| Flexural | kg/cm² | D790 | 45000 | 55000 | 66000 | 80000 | 92000 | 105000 | 125000 |
| modulus | | | | | | | | | |
| Impact | kg/cm/ | D256 | 5 | 5 | 5 | 4 | 4 | 5 | 4 |
| strength | cm | | | | | | | | |
| (23° C.) | | | | | | | | | |
| Pencil | — | D2240 | HB | HB | HB | F | F | F | F |
| hardness | | | | | | | | | |
| Heat | ° C. | D648 | 110 | 130 | 135 | 150 | 155 | 140 | 135 |
| distortion | | | | | | | | | |
| temp. | | | | | | | | | |
| Density | g/cm³ | D792 | 1.28 | 1.4 | 1.65 | 1.95 | 2.3 | 2.65 | 3.1 |
| Thermal | 10⁻⁵/° C. | D696 | 5.5 | 5 | 4.5 | 4 | 3.6 | 3.2 | 2.8 |
| expansion | | | | | | | | | |
| coefficient | | | | | | | | | |

Since cerium oxide is expensive, it is optional to add 5-10% zinc oxide (ZnO), 5-10% barium sulfate (BaSO4), or a combination thereof to reduce the cost and retain the property of high density.

It must be pointed out that the embodiments described above are only some embodiments of the present invention. All equivalent products which employ the concepts disclosed in this specification and the appended claims should fall within the scope of the present invention.

What is claimed is:

1. An electroplatable high-density plastic, comprising cerium oxide and at least one of polyphenylene sulfide (PPS) and high-rigidity nylon (MXD6), wherein the cerium oxide accounts for 20% to 80% by weight of the electroplatable high-density plastic.

2. The electroplatable high-density plastic of claim 1, wherein the electroplatable high-density plastic has a tensile strength of 652 to 1,100 kg/cm², as measured according to ASTM D638.

3. The electroplatable high-density plastic of claim 1, wherein the electroplatable high-density plastic has an elongation rate of 0.2 to 5%, as measured according to ASTM D640.

4. The electroplatable high-density plastic of claim 1, wherein the electroplatable high-density plastic has a flexural strength of 772 to 1,600 kg/cm², as measured according to ASTM D790.

5. The electroplatable high-density plastic of claim 1, wherein the electroplatable high-density plastic has a flexural modulus of 40,500 to 169,000 kg/cm², as measured according to ASTM D790.

6. The electroplatable high-density plastic of claim 1, wherein the electroplatable high-density plastic has a density of 1.28 to 3.73 g/cm³, as measured according to ASTM D792.

7. The electroplatable high-density plastic of claim 1, wherein the electroplatable high-density plastic has a shrinkage ratio of 0.3 to 0.69 cm/cm, as measured according to ASTM D955.

8. The electroplatable high-density plastic of claim 1, wherein the electroplatable high-density plastic has a pencil hardness of HB to 3H, as measured according to ASTM D2240.

9. The electroplatable high-density plastic of claim 1, wherein the at least one of polyphenylene sulfide and high-rigidity nylon accounts for 20% to 80% by weight of the electroplatable high-density plastic.

10. The electroplatable high-density plastic of claim 1, wherein the cerium oxide accounts for 40% to 80% by weight of the electroplatable high-density plastic.

11. The electroplatable high-density plastic of claim 10, wherein the electroplatable high-density plastic has a tensile strength of 700 to 857 kg/cm², as measured according to ASTM D638.

12. The electroplatable high-density plastic of claim 10, wherein the electroplatable high-density plastic has an elongation rate of 0.8 to 3%, as measured according to ASTM D640.

13. The electroplatable high-density plastic of claim 10, wherein the electroplatable high-density plastic has a flexural modulus of 51,000 to 169,000 kg/cm², as measured according to ASTM D790.

14. The electroplatable high-density plastic of claim 10, wherein the electroplatable high-density plastic has a density of 1.65 to 3.73 g/cm³, as measured according to ASTM D792.

15. The electroplatable high-density plastic of claim 3, wherein the at least one of polyphenylene sulfide and high-rigidity nylon (MXD6) accounts for 20% to 60% by weight of the electroplatable high-density plastic.

16. The electroplatable high-density plastic of claim 1, further comprising at least one of zinc oxide and barium sulfate.

17. The electroplatable high-density plastic of claim 1, wherein the cerium oxide has an average particle diameter of 0.2 to 40 μm.

18. The electroplatable high-density plastic of claim 1, comprising a metal plating layer constituting a surface of the electroplatable high-density plastic.
